(19) United States
(12) Patent Application Publication
(10) Pub. No.: US 2009/0261604 A1
(43) Pub. Date: Oct. 22, 2009

(54) Pet Waste Collection Tool with Integrated Leash

(76) Inventors: Gaspar G. Rodriguez, Belen, NM (US); Ronald C. Rodriguez, Belen, NM (US)

Correspondence Address: ERIC HANSCOM, 7395 PORTAGE WAY, CARLSBAD, CA, 92011, US

(21) Appl. No.: 12/487,515

(22) Filed: Jun. 18, 2009

Related U.S. Application Data
(63) Continuation-in-part of application No. 12/106,321, filed on Apr. 20, 2008.

(51) Int. Cl. A01K 29/00; B65H 75/34

(52) U.S. Cl. 294/1.3; 119/796

(57) ABSTRACT

A pet waste collection tool having an integrated leash is disclosed. The tool includes a retractable grasping device that can be retracted within the body portion of the tool. The retractable grasping device includes a grasping portion that has a means of attaching a bag. A trigger for activating the grasping portion enables a user to collect objects such as fecal matter within the attached bag. The leash is retractably stored within the body portion. A rotatable bag holder and a light source are also included. An arm holder helps secure the tool to the user during use.

### CROSS REFERENCE TO RELATED APPLICATIONS

This application is a continuation-in-part of U.S. patent application Ser. No. 12/106,321 filed on Apr. 20, 2008, the entirety of which is hereby incorporated by reference.

### STATEMENT REGARDING FEDERALLY SPONSORED RESEARCH OR DEVELOPMENT

This invention was not federally sponsored.

### BACKGROUND OF THE INVENTION

1Field of the Invention

This invention relates to the general field of handheld devices, and more specifically toward a pet waste collection tool having an integrated leash. The tool includes a retractable grasping device that can be retracted within the body portion of the tool. The retractable grasping device includes a grasping portion that has a means of attaching a bag. A trigger for activating the grasping portion enables a user to collect objects such as fecal matter within the attached bag. The leash is retractably stored within the body portion. A rotatable bag holder and a light source are also included. An arm holder helps secure the tool to the user during use.

When being walked, pets frequently have the need to answer nature's call. In many instances, this requires the pet owner to “clean up” after their pet. Such activity typically occurs by the pet owner bending down and using their hands to scoop the pet waste into a plastic bag. Such a method may present difficulty for pet owners who are not flexible or able to bend in such a position. Further, some pet owners may not want to risk potential contact with the pet waste and may opt not to clean up after their pet. Such behavior can anger property owners, can lead to uncleanly walking areas, and can increase the spread of bacteria and disease—all of which is undesirable. To alleviate the problem, some pet waste collection tools have been developed. While helpful, it is difficult for some pet owners to use such a tool in one hand while trying to contain their pet on a leash with the other hand.

Therefore, there is a current need for a pet waste collection tool having a retractable grasping device and an integrated leash that is lightweight, compact, and easy to use.

2Summary of the Invention

The pet waste collection tool of the current invention provides such a solution by having a body portion, a grasping trigger, a retractable grasping device, a leash attachment member, and a leash. It may also include a retractable trigger, leash trigger, light source, arm holder, and rotatable bag holder.

The body portion of the pet waste collection tool is lightweight and incorporates the various components of the device. The retractable grasping device includes an extendable portion and a grasping portion. The extendable portion allows for the grasping portion to be extended away from the body portion and retracted next to the body portion. The grasping portion is open and closed by the grasping trigger, thereby enabling a user to easily grasp portions from a distance. Optionally, the retractable trigger regulates the length of the extending portion by locking it in place or releasing it for expansion and retraction.

The body also includes a leash attachment member that secures the leash to the body. The leash attachment member is preferably a retractable device that allows the leash to extend out from and retract within the body. A leash trigger and spring mechanism can regulate the extension of the leash.

The pet waste collection tool can also include a light source that is preferably integrated into the body. An arm holder affixed to the body can also aid in securing the pet waste collection tool to the user. Bags used in the collection of pet waste are stored within a rotatable bag holder. The rotation of the rotatable bag holder allows for convenient placement of the bags during different instances of use.

It is an object of the invention to provide a pet waste collection tool that is lightweight and convenient to carry.

It is a further object of the invention to provide a pet waste collection tool that enables a user to grasp objects located on the ground without requiring the user to bend over.

It is another object of the invention to provide a pet waste collection tool that enables a user leash their pet without the need of an additional device.

It is a final object of this invention to provide a pet waste collection tool with an integrated bag storage device.

There has thus been outlined, rather broadly, the more important features of the invention in order that the detailed description thereof may be better understood, and in order that the present contribution to the art may be better appreciated. There are additional features of the invention that will be described hereinafter and which will form the subject matter of the claims appended hereto. The features listed herein and other features, aspects and advantages of the present invention will become better understood with reference to the following description and appended claims. The accompanying drawings, which are incorporated in and constitute part of this specification, illustrate embodiments of the invention and, together with the description, serve to explain the principles of the invention.

### BRIEF DESCRIPTION OF THE FIGURES

FIG. 1 is a side perspective view of the pet waste collection tool with the rotatable bag holder in the extended position.

FIG. 2 is a front view thereof.

FIG. 3 is a back view thereof.

FIG. 4 is a right side view thereof.

FIG. 5 is a left side view thereof.

FIG. 6 is a top view thereof.

FIG. 7 is a bottom view thereof.

FIG. 8 is a side perspective view of the pet waste collection tool with the rotatable bag holder in the collapsed position.

FIG. 9 is an internal side perspective view of the pet waste collection tool with the rotatable bag holder in the collapsed position.

FIG. 10 is a side perspective view of the pet waste collection tool with the grasping portion in the open position.

FIG. 11 is a side perspective view of the pet waste collection tool with the retractable grasping device in the extended position.

### DETAILED DESCRIPTION OF THE FIGURES

Many aspects of the invention can be better understood with the references made to the drawings below. The components in the drawings are not necessarily drawn to scale. Instead, emphasis is placed upon clearly illustrating the components of the present invention. Moreover, like reference numerals designate corresponding parts throughout the several views in the drawings.

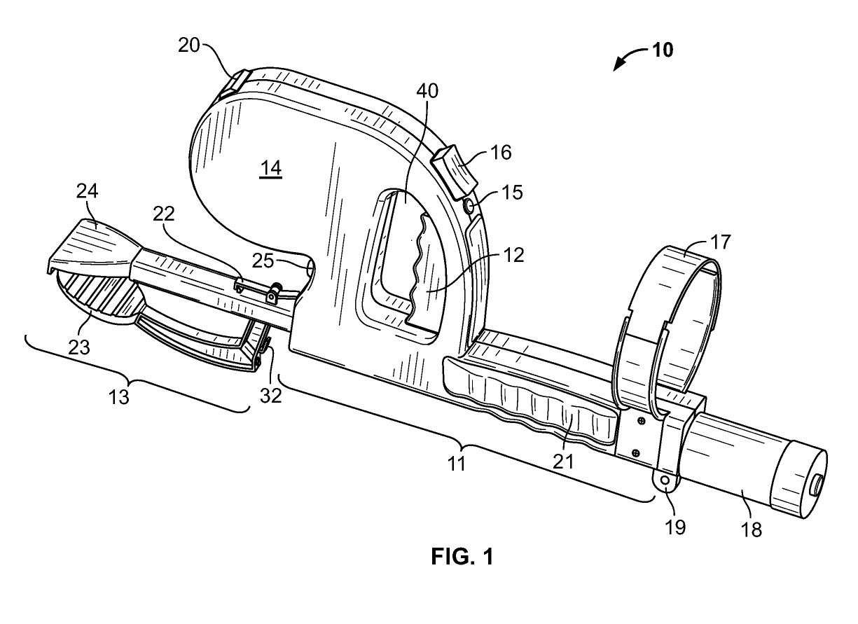

FIG. 1 is a side perspective view of the pet waste collection tool with the rotatable bag holder in the extended position. The pet waste collection tool, generally referred to by numeral 10 throughout the drawings, includes a body portion 11. Secured to the body portion 11 is a retractable grasping device 13.

The retractable grasping device 13 can be extended from and retracted within the body portion 11. This movement is regulated by a retractable trigger (not shown in this figure). A movable first claw 23 and an immovable second claw 24 make up the grasping portion of the retractable grasping device 13. A bag retention clip 22, connected to the second claw 24, and a bag retention hook 32, connected to the first claw, are used to secure a bag to the grasping portion of the device. A grasping trigger 12 can be pressed and released to move the first claw 23 closer to or further from the second claw 24 thereby closing and opening the grasping portion. This motion can be used to grasp objects, such as pet fecal matter.

The body portion 11 also includes an integrated leash attachment member 14. The leash attachment member 14 secures a leash to the pet waste collection tool 10. The leash is preferably retractably stored within the leash attachment member 14. In this embodiment of the invention, the leash passes through the leash opening 20. A leash trigger 16 regulates the retraction of the leash. For example, the leash can be spring loaded within the leash attachment member 14. A user can apply a force to the leash to withdraw it; however, if the force is no longer applied, it is withdrawn back into the leash attachment member 14. The leash trigger 16 can be used to hold the leash in place such that it will not retract even though there is no force being applied to the leash. Alternatively, The leash will be retracted within the leash attachment member 16 when the leash trigger 16 is pressed.

A light source 25 can be integrated into the body portion 11. The light source 25 can be used to illuminate the area in front of the pet waste collection tool 10. This can aid users in grasping objects in poorly lit areas. Light emitting diodes, or LEDs, are preferably used as the light source, but other means of producing light are possible without departing from the scope of the claimed invention. A light source button 15 can be used to turn the light source 25 on and off.

Various features can be integrated into the body portion to enable a user to conveniently and effectively hold the pet waste collection tool 10. A user can grasp the pet waste collection tool 10 by placing his or her hand through an opening 40 in the body portion 11 where the grasping trigger 12 is located. A side handgrip 21 aids the user's other hand to grip the pet waste collection tool 10. An arm holder 17 can also hold the arm of a user. The arm holder 17 encircles the user's arm and secures it to the body portion 11 of the pet waste collection tool 10. In one embodiment, the arm holder 17 uses hook and loop fastener (known by its brand name Velcro®) straps to secure an arm to the body portion 11. Alternatively, semi-rigid plastic straps can be used, whereby the user bends the straps apart to insert his or her arm, and then they released to retain the arm within the straps. In another alternative embodiment, belts with buckles are used.

As stated previously, bags, preferably plastic, can be secured to the grasping portion. The bags allow a user to grasp objects, such as pet fecal matter, without it coming in direct contact with the first claw 23 or second claw 24. These bags can be stored within a rotatable bag holder 18. The rotatable bag holder 18 is connected to the body portion 11 by a pivot point 19, whereby the rotatable bag holder 18 rotates about the pivot point 19. Alternatively, the bag holder can be secured to the body portion in a fixed position.

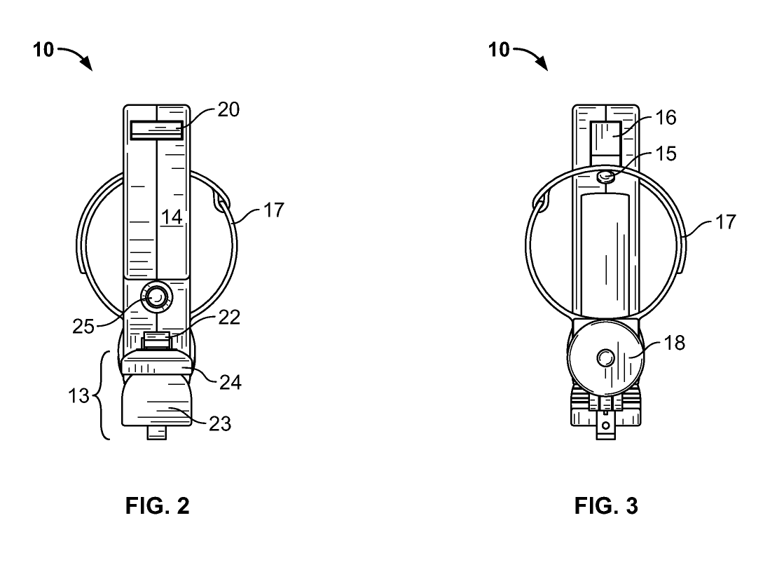

FIG. 2 is a front view of the pet waste collection tool with the rotatable bag holder in the extended position. The retractable grasping device 13 is shown with the first claw 23 and second claw 24 in the closed position. The bag retention clip 22 is shown on top of the second claw 24. Shown beneath the leash attachment 14 member is the light source 25. The leash is withdrawn from and retracted into the leash opening 20 preferably located at the top of the leash attachment member 14.

FIG. 3 is a back view of the pet waste collection tool with the rotatable bag holder in the extended position. The rotatable bag holder 18 holds a plurality of bags for use by the user. The arm holder 17 is used to help secure the pet waste collection tool 10 to the user. Also shown in this view are the light source button 15 and the leash trigger 16.

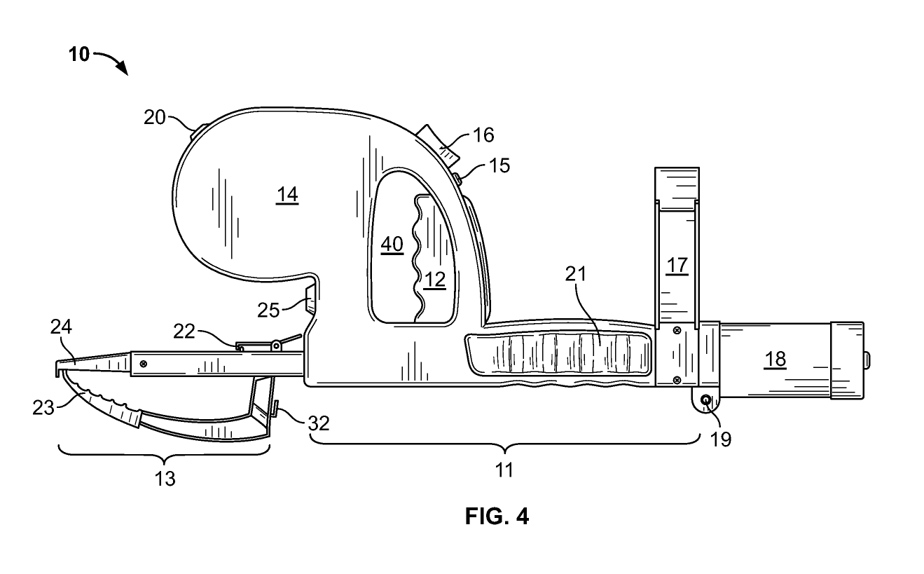

FIG. 4 is a right side view of the pet waste collection tool with the rotatable bag holder in the extended position. The retractable grasping device 13 is shown in the retracted position with the first claw 23 and the second claw 24 in the closed position.

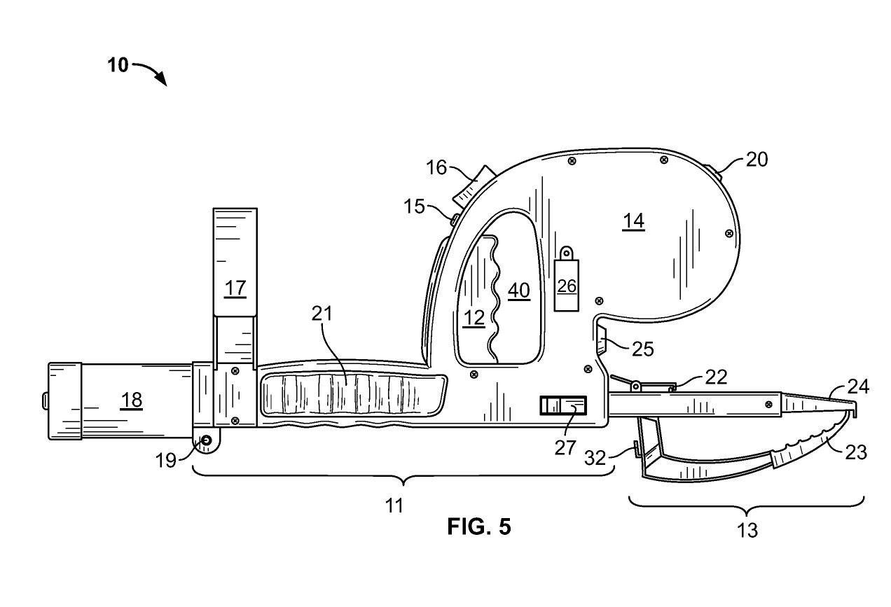

FIG. 5 is a left side view of the pet waste collection tool with rotatable bag holder in the extended position. The retractable grasping device 13 is shown in the retracted position with the first claw 23 and the second claw 24 in the closed position. A retractable trigger 27 is used to regulate the extension of the retractable gasping device 13; it enables and prevents the withdrawal and retraction of the retractable grasping device 13. Preferably, the retractable grasping device 13 includes an extendable portion that is a series of coaxially expanding tubes. The retractable trigger 27 can regulate the expansion of the tubes whereby a user can press the retractable trigger 27 to pull out and push in the grasping portion of the retractable grasping device 13; otherwise the retractable grasping device is locked in place. The series of coaxially expanding tubes allows the grasping portion to extend a distance greater than the length of the body portion 11. In an alternative embodiment, the extendable portion can consist of a single bar that can be withdrawn from the body portion 11. In this iteration, the retractable trigger 27 can act as a braking device (or release thereof) that prevents the movement of the extendable portion.

Also shown in FIG. 5 is a battery cover 26. The battery cover 26 allows access to a battery compartment. The battery compartment stores a battery that is used to power the light source 25 when activated by the light source button 15.

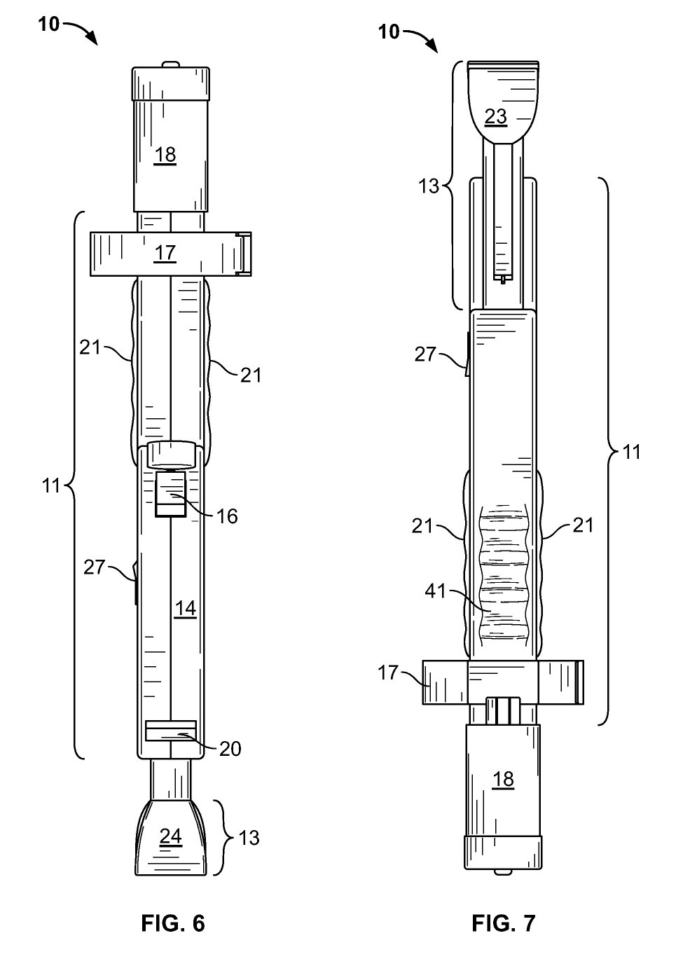

FIG. 6 is a top view of the pet waste collection tool with the rotatable bag holder in the extended position. The second claw 24 of the retractable grasping device 13 is shown extending beyond the leash attachment device 14 even though the retractable grasping device 13 is fully retracted within the body portion 11. This figure shows two side handgrips 21 on either side of the body portion 11. The retractable trigger 27 is shown on one side of the body portion.

FIG. 7 is a top view of the pet waste collection tool with the rotatable bag holder in the extended position. The rotatable bag holder 18 extends from the end of the body portion 11. A bottom handgrip 41 is shown in between the two side handgrips 21. The retractable grasping portion 13 is shown retracted within the body portion 11.

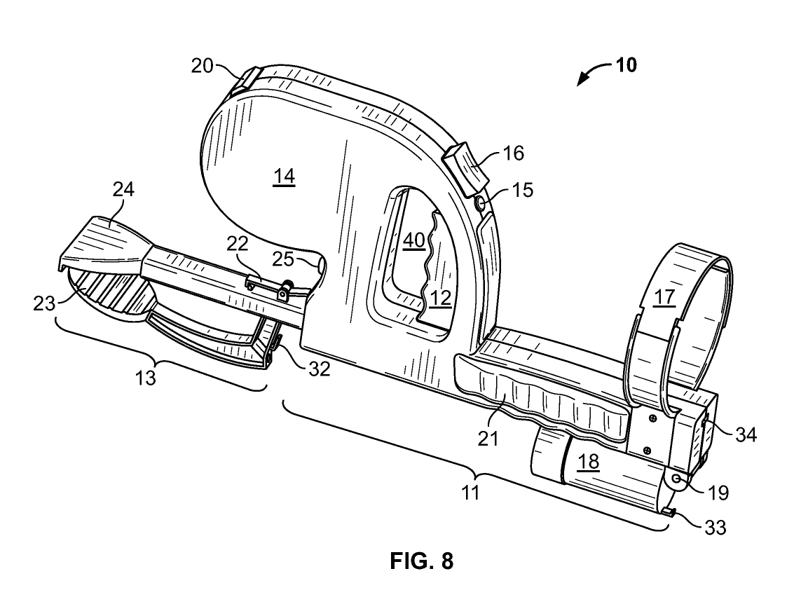

FIG. 8 is a side perspective view of the pet waste collection tool with the rotatable bag holder in the collapsed position. In this view, the rotatable bag holder 18 has been rotated around the pivot point 19 into the collapsed position. A bag holder clip 33 on one end of the rotatable bag holder 18 can be inserted into a clip opening 34. The bag holder clip 33 and the clip opening 34, when connected together, secure the rotatable bag holder 18 in the extended position. However, a user can disconnect the bag holder clip 33 from the clip opening 34 by applying a sufficient force.

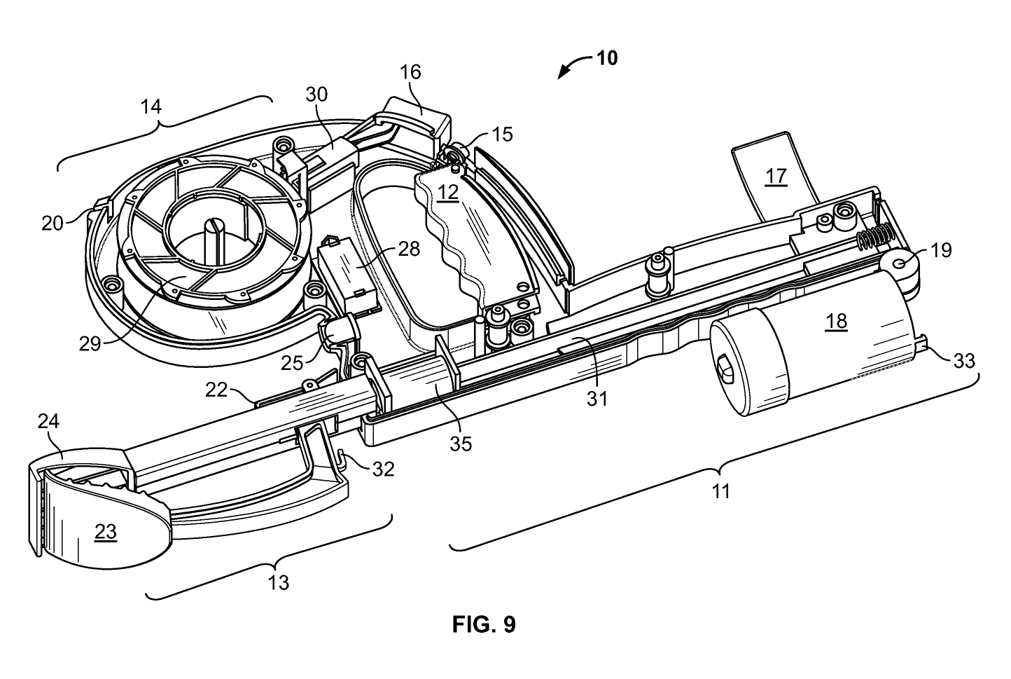

FIG. 9 is an internal side perspective view of the pet waste collection tool with the rotatable bag holder in the collapsed position. The retractable grasping device 13 is retracted within the body portion. The first claw 23 is in the closed position next to the second claw 24. An extendable portion retention mechanism 35 regulates the position of the retractable grasping device 13. A cavity for extendable portion storage is an open area that can hold the extendable portion of the retractable grasping device 13. The retractable trigger, not shown in this view, regulates the extendable portion retention mechanism 35 thereby preventing or allowing the extension and retraction of the retractable grasping device 13. The grasping trigger 12 is used to open and close the retractable grasping device 13, where the retractable grasping device 13 is opened and closed by moving the first claw 23 away from and closer to the second claw 24, respectively.

The body portion 11 includes a light source 25 that is turned on and off by a light source button 15. A battery (not shown) contained within a battery case 28 powers the light source 25.

A leash can be stored within and retracted from the leash attachment member 14. Inside of the leash attachment member 14 is a leash retaining cylinder 29. A leash can be wound around the leash retaining cylinder 29 and withdrawn though the leash opening 20.

In a preferred embodiment, the leash retaining cylinder 29 is under an elastic force, such as from a spring, that rotates the leash retaining cylinder 29 and retracts the leash. An opposing force is required to withdraw and/or maintain the extension of the leash from the leash retaining cylinder 29. A leash retaining mechanism 30, activated by the leash trigger 16, can apply a braking force to the leash retaining cylinder 29 thereby preventing it from rotating and retracting the leash. In this fashion, a user can attach a leash to his or her pet and the leash will elastically withdraw and retract depending on the force applied by the pet. However, the leash can be kept at a fixed position by pressing, and thus activating, the leash trigger 16.

In an alternative embodiment, the leash retaining mechanism 30 applies a braking force unless the leash trigger 16 is activated. In this fashion, the leash will only withdraw and retract if the leash trigger is pressed and thus activated.

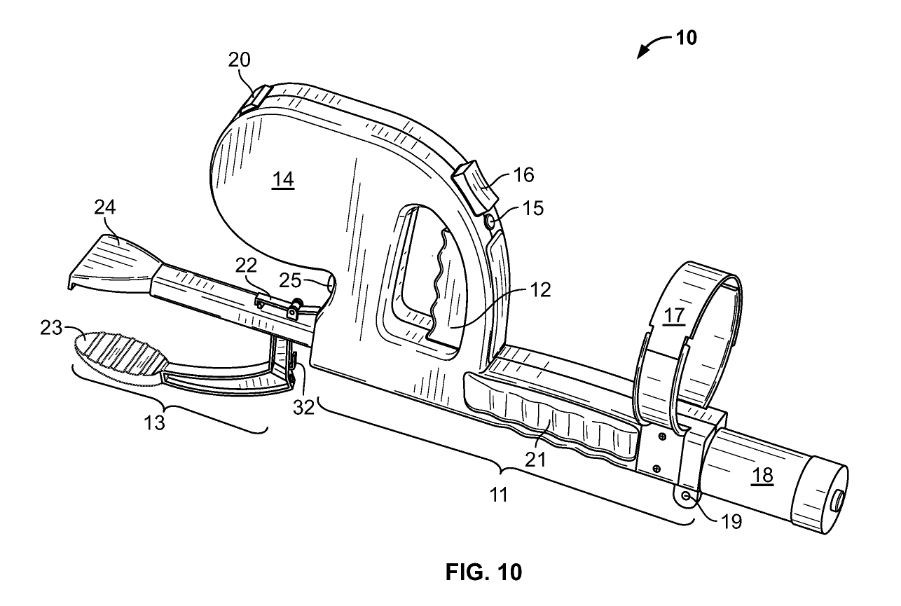

FIG. 10 is a side perspective view of the pet waste collection tool with the grasping portion in the open position. The first claw 23 is moved away from the second claw 24 by pressing the grasping trigger 12 thereby placing the grasping portion in the open position. Alternatively, pressing the grasping trigger 12 causes the first claw 23 to move towards the second claw 24 thereby closing the grasping portion.

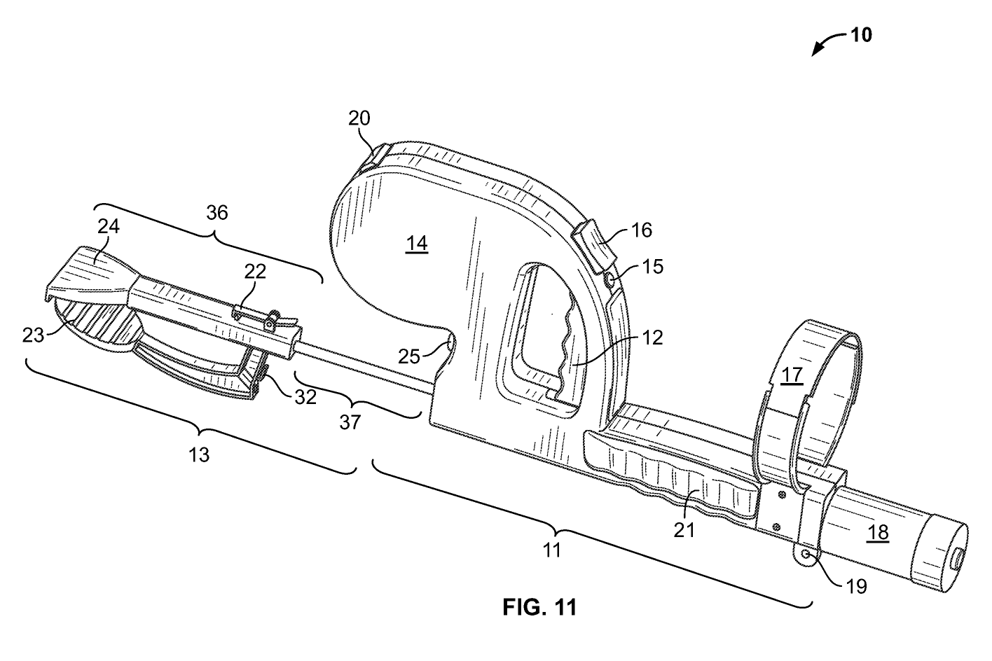

FIG. 11 is a side perspective view of the pet waste collection tool with the retractable grasping device in the extended position. The retractable grasping device 13 includes a grasping portion 36 and an extendable portion 37. The grasping portion 36 is shown in the closed position, with the first claw 23 proximate to the second claw 24. Also, the leash trigger 16 and the grasping trigger 12 are shown in their activated, or pressed, states.

The process of walking a pet and collecting fecal matter is made simple with pet waste collection tool of the current invention. The leash can be withdrawn from the leash attachment member and secured to the pet. The user can insert his or her arm through the arm holder and insert his or her hand through the opening in the body portion to hold onto the pet waste collection tool.

A plastic bag can be secured to the grasping portion of the retractable grasping device. The plastic bag can be withdrawn from the rotatable bag holder. One part of the open end of the bag is secured to the second claw using the bag retention clip. The other end of the open bag can be placed around the bag retention hook. This creates a plastic barrier around and between the first and second claws of the grasping portion. The user extends the retractable grasping device by pressing the retractable trigger and withdrawing the retractable grasping device from the body, thereby exposing the extendable portion. Activating the grasping trigger, which closes the grasping portion around the fecal matter, allows the user to collect the fecal matter. The plastic bag can then be removed from the grasping portion and disposed of. The extendable portion of the retractable grasping device is then retracted within the body portion by activating the retractable trigger and applying an inward force.

These steps can also be performed in poorly lit areas. The light source, preferably made of LED lights, is activated by pressing the light source button. This will illuminate an area in front of the pet waste collection tool to aid in the collection of fecal matter or simply to illuminate an area where the user is walking.

It should be understood that while the preferred embodiments of the invention are described in some detail herein, the present disclosure is made by way of example only and that variations and changes thereto are possible without departing from the subject matter coming within the scope of the following claims, and a reasonable equivalency thereof, which claims I regard as my invention.

All of the material in this patent document is subject to copyright protection under the copyright laws of the United States and other countries. The copyright owner has no objection to the facsimile reproduction by anyone of the patent document or the patent disclosure, as it appears in official governmental records but, otherwise, all other copyright rights whatsoever are reserved.

What we claim is:

1. A pet waste collection tool comprising
a body portion, a leash attachment member, and a retractable grasping device,
where the leash attachment member is integrated into the body portion, where the leash attachment member secures a leash to the body portion,
where the retractable grasping device can be at least partially withdrawn from and retracted within the body portion, where the retractable grasping device comprises a grasping portion, where the grasping portion can be opened or closed.

2. The pet waste collection tool of claim 1, wherein the grasping portion comprises a means of retaining a bag.

3. The pet waste collection tool of claim 2, wherein the means of retaining a bag comprises a bag retention clip.

4. The pet waste collection tool of claim 1, further comprising a grasping trigger, where the grasping trigger, when pressed and released, opens and closes the grasping portion.

5. The pet waste collection tool of claim 1, wherein the grasping portion comprises a first claw and a second claw.

6. The pet waste collection tool of claim 5, wherein the first claw is movable and the first claw is fixed.

7. The pet waste collection tool of claim 1, further comprising a light source.

8. The pet waste collection tool of claim 1, further comprising a bag holder.

9. The pet waste collection tool of claim 8, further comprising a pivot point, wherein the bag holder pivots around the pivot point.

10. The pet waste collection tool of claim 1, further comprising an arm holder.

11. The pet waste collection tool of claim 1, wherein the leash attachment member comprises a means for retracting the leash within the leash attachment member, where the leash can be withdrawn from and retracted within the leash attachment member.

12. The pet waste collection tool of claim 11, further comprising a leash trigger, where the leash trigger regulates the withdrawal and retraction of the leash within the leash attachment member.

13. The pet waste collection tool of claim 1, further comprising a retractable trigger, where the retractable trigger enables and prevents the withdrawal and retraction of the retractable grasping device.

14. A pet waste collection tool comprising
a body portion, a leash attachment member, a retractable grasping device, and a grasping trigger,
where the leash attachment member is integrated into the body portion, where the leash attachment member secures a leash to the body portion, where the leash attachment member comprises a means for retracting the leash within the leash attachment member, where the leash can be withdrawn from and retracted within the leash attachment member,
where the retractable grasping device can be at least partially withdrawn from and retracted within the body portion, where the retractable grasping device comprises a grasping portion, where the grasping portion comprises a means of retaining a bag, where the grasping portion can be opened or closed, where the grasping trigger, when pressed and released, opens and closes the grasping portion.

15. The pet waste collection tool of claim 14, further comprising a light source.

16. The pet waste collection tool of claim 14, further comprising a bag holder.

17. The pet waste collection tool of claim 14, further comprising an arm holder.

18. The pet waste collection tool of claim 14, further comprising a retractable trigger, where the retractable trigger enables and prevents the withdrawal and retraction of the retractable grasping device.

19. A method of collecting fecal matter comprising the steps of
obtaining a pet waste collection tool, where the pet waste collection tool comprises a body portion, a leash attachment member, and a retractable grasping device, where the leash attachment member is integrated into the body portion, where the leash attachment member secures a leash to the body portion, where the retractable grasping device can be at least partially withdrawn from and retracted within the body portion, where the retractable grasping device comprises a grasping portion, where the grasping portion can be opened or closed, where the grasping portion comprises a means of retaining a bag,
securing a bag to the grasping portion, and
closing the grasping portion around the fecal matter,
whereby the fecal matter is enclosed within the bag.

20. The method of claim 19, further comprising the steps of
removing the bag containing the fecal matter from the grasping portion, and disposing of the fecal matter.
